(19) United States
(12) Patent Application Publication
(10) Pub. No.: US 2007/0285509 A1
(43) Pub. Date: Dec. 13, 2007

(54) Parallax-Barrier Type Stereoscopic Display Apparatus

(75) Inventor: Young Hoon Lee, Seoul (KR)

Correspondence Address: WORKMAN NYDEGGER, 60 EAST SOUTH TEMPLE, 1000 EAGLE GATE TOWER, SALT LAKE CITY, UT, 84111, US

(73) Assignee: MASTER IMAGE CO., LTD., Seoul (KR)

(21) Appl. No.: 11/722,478

(22) PCT Filed: Dec. 22, 2005
(86) PCT No.: PCT/KR05/04447

§ 371 Date: Jun. 21, 2007

(30) Foreign Application Priority Data
Dec. 22, 2004 (KR) 10-2004-0110501

(51) Int. Cl. H04N 13/00

(52) U.S. Cl. 348/43

(57) ABSTRACT

The parallax-barrier type stereoscopic display apparatus is equipped with a light source module comprising a red (R) light source, a green (G) light source and a blue (B) light source, and a light diffusion plate for diffusing lights generated by said light source module. Said parallax-barrier type stereoscopic display apparatus also comprises: an emitting light module which displays each colored light generated from each colored light source by said light source module per unit time (T1) on the entire light-outputting surface of said light diffusion plate in sequence; a display panel in which pixels for the left eye and pixels for the right eye are arranged one after the other with pixel unit, and also which adjusts with pixel unit the penetrating amount of each colored light displayed in sequence by said emitting light module according to image signals, So as to display images for the left eye and images for the right eye arranged one after the other; and a barrier which is disposed with a predetermined distance from said display panel so as to selectively show images for the left eye and images for the fight eye; and thus said parallax-barrier type stereoscopic display apparatus can present images with the high resolution of picture images even on a small screen, owing to the capability of displaying stereoscopic images with pixel units by displaying R, G and B in sequence at each pixel according to image signals.

### TECHNICAL FIELD

The present invention relates to a Liquid Crystal Display Device, in particular, a stereoscopic image display device.

### BACKGROUND ART

The informational communication technology has been developed to the extent that text, vocal messages and images can be processed with high speed on a digital terminal which further provides multimedia services supporting two-dimensional images and vocals. It is expected that the informational communication technology will be further developed to provide three-dimensional multimedia service for stereoscopically real impact.

Generally, three-dimensionally displayed stereoscopic images are possible by a theory of stereo vision seen through eyes. A significant factor for stereoscopic effects is the difference in visional senses, namely visional senses of the both eyes of a person, due to the distance of about 65mm between the eyes. That is, each of the eyes of a person sees an object as different images from different angles, and such different images are transmitted through retina to the brain, and then the brain combines said different images to reproduce the original three-dimensional image of the object with depth and reality. This process is generally called “stereography”.

There are two types of stereoscopic display apparatus, depending on whether wearing a separate set of spectacles is needed: stereoscopic display apparatus with spectacles and autostereoscopic display apparatus without spectacles.

While the stereoscopic display apparatus type with spectacles gives a user (observer) an additional burden to wear a pair of particular spectacles, the autostereoscopic display apparatus type without spectacles allows the user (the observer) to directly watch the screen to feel stereoscopic images presented thereon and thus solves disadvantageous problems of the stereoscopic display apparatus. Thus, there are many studies and developments going on in the filed of autostereoscopic display apparatus nowadays.

The autostereoscopic display apparatus without spectacles is also divided into two types: lenticular type and parallax-barrier type.

TFR-LCD is generally operated for displaying RGB by equally trisecting a pixel (or cell) and then applying each fluorescent paint onto corresponding divisional areas of R, G and B to display images of the R, G and B through a back light.

In lenticular type, a display panel is arranged with left-side images and right-side images on vertical cell (R, G, B) units one after the other in the vertical direction (vertical interlace type), and each of particularly produced refractive lenses is attached in front of the left-side and the right-side images, respectively, so that the left-side and the right-side images can be separated from each other to present a stereoscopic vision.

Meanwhile, in parallax-barrier type, a vertically formed blocking shield is installed in front of images viewed through the left and right eyes, and thus two images composited through a slit are separated to be observed as a stereoscopic vision.

Generally, as shown in FIG. 1, the parallax-barrier type is constituted with a display panel (110) and a barrier (120) which is disposed with a certain distance from said panel (110).

The pixel pattern of the display panel (110) is arranged in a repetitive order of R, G, B for the left eye and R, G, B for the right eye.

The barrier (120) is constituted with a portion (121) through which the light from each pixel of the display panel (110) penetrates and a blocking shield (122) which blocks the light and is disposed so as to allow the light from the pixel for the left eye comes only into the left eye and the light from the pixel for the right eye comes only into the right eye. In other words, in the parallax-barrier type, the pixel of the display panel (110) is arranged with the pixel for the left eye and the pixel for the right eye of the R, G, B pixel units (lengthwise interlace type), and a blocking shield (122) is installed at every interspace between the pixel for the left eye and the pixel for the right eye with a predetermined distance from said pixel for the left eye and the pixel for the right eye, so as to allow images for the left eye to come in the sight only of the left eye and images for the right eye to come in sight only of the right eye, respectively, and thus a stereoscopic vision can be presented.

In this connection, in using autostereoscopic display apparatus with an LCD display, the lenticular type is inferior to the parallax-barrier type in stereoscopic effect, and further the lenticular type is difficult to compatibly use with normal 2D pictures. Thus, now the development is trending towards mostly the parallax-barrier type.

However, when a stereoscopic image is displayed by the parallax-barrier type with trisected R, G and B patterns of a pixel of the conventional TFT-LCD, it occasionally occurs that a part of R, G and B units is blocked and thus is not displayed due to the thickness and the position of the blocking shield disposed at the interspace between pixels, which eventually leads to ineffective display of stereoscopic images.

In order to solve such problems, a technique has been presented in which said blocking shield is subtilizingly arranged by R, G and B units, such as positioned between R and G, G and B or B and R, and images for the left eye and images for the right eye are also arranged by R, G and B units which are subdivided into left R, right G, left B, right R, left G, right B, and so on.

However, said improved technique has problems such that the visual angle becomes extremely narrowed and the viewing distance gets specifically restricted due to the thickness of blocking shield and the narrow distance between each blocking shield; and that the blocking shields should be more precisely produced with R, G and B units. Thus, the producing process becomes more difficult, the working efficiency gets lower, and the producing process gets more complicated because images for the left eye and images for the right eye should also be produced with R, G and B units.

### DISCLOSURE OF INVENTION

### Technical Problem

Thus to solve the problems of prior art, the present invention has its object to improve the resolution of the stereoscopic images and the visional angle as well as the viewing distance that determine the possible viewing range, by having a display panel adjust with pixel units the penetrating amount of the light generated by the light source module generating each colored light such as R, G and B in sequence, so that colored lights such as R, G and B are displayed in sequence on the entire surface of each pixel; and by disposing a blocking shield at a position with a predetermined distance from each pixel so as to selectively show images for the left eye and images for the right eye.

### Technical Solution

In order to achieve said object, the parallax-barrier type stereoscopic display apparatus according to an examples of the present invention comprises:

an emitting light module for displaying plurality of colored lights in sequence per unit time (T1);

a display panel, in which pixels for the left eye and pixels for the right eye are arranged one after the other with pixel units, and also which adjusts with pixel units the penetrating amount of each colored light displayed in sequence by said emitting light module, so that images for the left eye and images for the right eye which are arranged one after the other are displayed; and

a barrier which is disposed with a predetermined distance from said display panel and selectively shows images for the left eye and images for the right eye. 122 Further, said emitting light module may comprises a light source module including plurality of colored-light sources and a light diffusion plate for diffusing lights generated by said light source module, and each colored light source of said light source module may generate each colored light per unit time (T 1) and sequentially displays them on the entire light-outputting surface of said light diffusion plate.

Further, said plurality of colored lights may include red (R) light, green (() light and blue (B) light, and said plural colored lights may include red (R) light source, green (G) light source and blue (B) light source.

Further, the pixel of the display panel may adjust the penetrating amount of each colored light within the unit time (T1) per time (T2) unit represented by the unit time (T1) multiplied by the number of each colored light (N) included in said emitting light module, so that images for the left eye can be displayed at the pixel for the left eye and images for the right eye are displayed at the pixel for the right eye.

Further, in the parallax-barrier type stereoscopic display apparatus according to an examples of the present invention, said barrier may be an barrier exclusively used for stereoscopic display, or may comprise a constitution of TN-LCD or STN-LCD for converting modes between plane/stereoscopic view.

Further, said barrier may comprise a blocking shield disposed at every two pixels in the vertical direction, and the pitch of said blocking shield can be determined within the range of Pp×0.4 to Pp×0.8 when Pp is determined within the range of 2×Dp×0.8 to 2×Dp; and here, Pp is a panel pitch and Dp is dot pitch of a pixel, Pp=2×Dp×(S−L)/S, S is the viewing distance, and L is the distance between the display panel and the barrier.

### BRIEF DESCRIPTION OF THE DRAWINGS

FIG. 1 is a drawing of the constitution of a general parallax-barrier type stereoscopic display apparatus

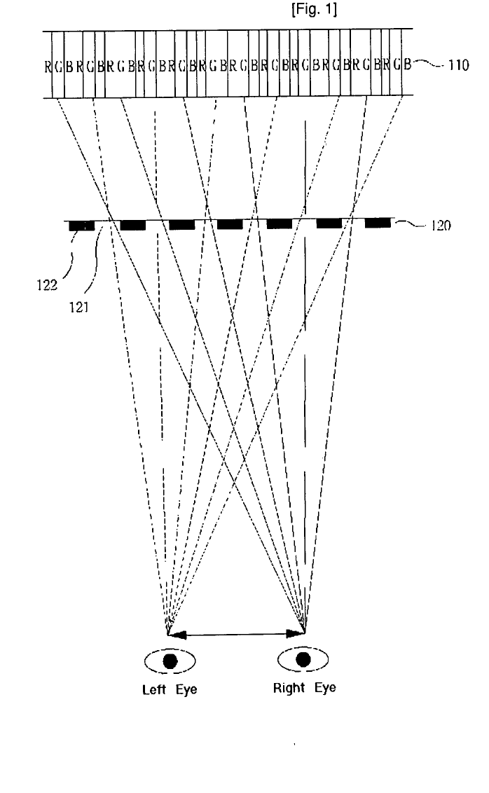

FIG. 2 is a drawing of the constitution of the parallax-barrier type stereoscopic display apparatus according to an example of the present invention.

FIG. 3 is an outline showing the relationship between elements for determining the pitch of the blocking shield according to an example of the present invention.

### BEST MODE FOR CARRYING OUT THE INVENTION

Hereinafter, the present invention is explained in detail based on the drawings attached hereto.

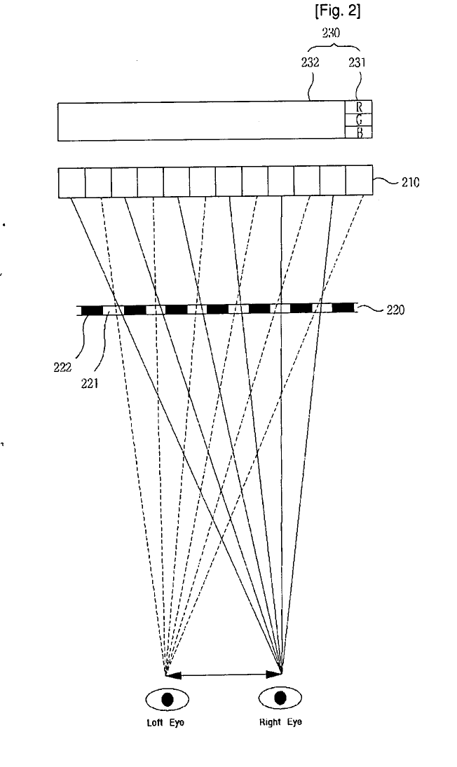

FIG. 2 is a drawing of the constitution of the parallax-barrier type stereoscopic display apparatus according to an example of the present invention.

As shown in FIG. 2, the parallax-barrier type stereoscopic display apparatus according to an example of the present invention may comprise an emitting light module (230), a display panel (210) and a barrier (220). Here, the emitting module (230) may be equipped with a light source module (231) comprising at least a red (R) light source, a green (G) light source and a blue (B) light source, and a light diffusion plate (232) for diffusing lights generated by said light source module (231). Each colored light source (R, G, B, etc.) of said light source module (231) generates each colored light per predetermined unit time (T1), and said each generated colored light is displayed in sequence on the entire light-outputting surface of said light diffusion plate (232).

In order to enhance the brightness and to more easily display colors of stereoscopic images, said light source module (230) may comprise optional colored light sources such as white (W), etc. in addition to three general light sources of red (R), green (G) and blue (B); hereinafter, however each light source will be indicated as R, G and B for a simpler explanation. Further, currently, a dot light source such as LED, etc. is generally used for the emitting light module (231), but the conventional bar type light source also may be used as long as such bar type light source can generate each colored light per the predetermined unit time (T1). Here, the unit time (T1) indicates the time during which said light source module (231) generates each colored light of R, G and B, and the unit time (T1) is normally 2 to 5 □ but is not limited to it.

Further, in said display panel (210), pixels for the left eye and pixels for the right eye as pixel units may be arranged one after the other. Said display panel (210) adjusts with pixel units the amount of each colored light such as R, G and B, which penetrates each pixel and is displayed in sequence by said emitting module (230) according to the predetermined image signals to display stereoscopic images. Accordingly, it is able with the display panel (210) that images for the left eye are displayed at pixels for the left eye and images for the right eye are displayed at pixels for the right eye one after the other.

Further, said barrier (220) is disposed with a predetermined distance from said display panel (210) and selectively shows a viewer images for the left eye only to his/her left eye and images for right eye only to his/her right eye. As mentioned above, the parallax-barrier type stereoscopic display apparatus according to an example of the present invention displays images on the entire pixel by adjusting the penetrating time of each colored light such as R, G and B; and does not display colors of images with R, G and B territorial units formed within a pixel. Thus, the present invention can prevent a part of R, G and B from being blocked due to misplacing the barrier (220) by a fine discrepancy. In said barrier, it is desirable to dispose a blocking shield at every two pixels in the lengthwise direction but is not limited to it.

Further, in the parallax-barrier type stereoscopic display apparatus according to an example of the present invention, it is possible to operate said barrier (220) with TN-LCD or STN-LCD for converting modes between plane/stereoscope (2D/3D) view. Accordingly, the blocking shield (222) can be switched between on/off, and this enables the stereoscopic display apparatus to convert its mode of 2D/3D. That is, in case of 2D mode, the blocking shield (222) gets off to let the light penetrate, so that 2D images can be presented; and in case of 3D mode, the blocking shield (222) gets on to block the light so that stereoscopic images can be presented.

Hereinafter, the operation principle of the parallax-barrier type stereoscopic display apparatus according to an example of the present invention as mentioned above will be discussed.

The pixel of the display panel adjusts the penetrating amount of each colored light within the unit time (T1) with the time (T2) unit represented by the unit time (T1) multiplied by the number (N) of each colored light source included in the emitting light module, so that images for the left eye are displayed at said pixels for left eye and images for the right eye are displayed at said pixels for the right eye. In an example, adjusting the penetrating amount of each colored light within the unit time (T1) can adjust the depth of the color of each pixel by adjusting the amount of the penetrating light according to how much an LCD is twisted per unit time (T1) but is not limited to it.

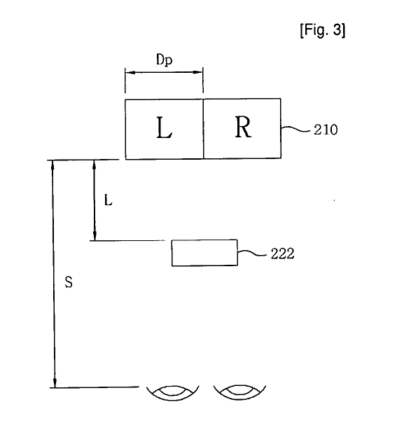

FIG. 3 is an outline showing the relationship between elements for determining the pitch of the blocking shield according to an example of the present invention.

In an example of the present invention, the barrier pitch (Bp) of a blocking shield (222) of the pixel unit is determined by the thickness, the viewing distance and the dot pictch (Dp) of the pixel of the display panel. Here, when a panel pitch (Pp) is defined by the sum of each pitch disposed at every interspace between a blocking shield and its closest blocking shield, the panel pitch (Pp) is determined within the range of 2Dp×0.8 to 2×Dp.

Also, the pitch of the blocking shield (222) (Bp) is determined within the range of Pp×0.4 to Pp×0.8.

The panel pitch (Pp) is determined by the following calculation:
Pp=2×Dp−(S−L)/(S)

Here, “S” indicates the viewing distance, “L” indicates the thickness of the display panel, namely, the distance between the display panel (210) and the barrier (220), and Dp indicates the dot pitch of the pixel, all of which are as shown in FIG. 4.

Although the desirable form of carrying out the present invention is explained in the above, a person skilled in the pertinent art would understand that the present invention can be variously modified and altered within the idea and the field of the present invention as recited in the following claims.

### INDUSTRIAL APPLIABILITY

As explained in the above in detail, the present invention controls R, G and B displays with its pixel unit to display stereoscopic images and thus demonstrate effects as follows:

In operating a stereoscopic display apparatus, RI G and B are displayed in sequence at each pixel according to image signals to present stereoscopic images with pixel units, so that images with high resolution can be repreoduced on a small screen.

Further, as mentioned above, R, G and B are displayed one by one in sequence at each pixel per unit time (T1) and thus stereoscopic images are displayed with pixel units, so that the blocking shield can be designed based on a pixel unit, and thus the position and pitch of the blocking shield (222) can be flexibly designed.

That is, the present invention is able to determine the pitch of the blocking shield (222) so as to allow the visional angel to be enlarged and the viewing distance to be elongated, and thus the producing process can be simplified compared to prior art and excellent stereoscopic images can be presented.

In addition, images of the left-side and the light-side are displayed with pixel units, not with R, G and B units, and thus the images of the left-side and the right-side are easily displayed.

Further, in the present invention, the barrier (22) is operated with TN-LCD or STN-LCD for converting modes between 2D/3D, and the blocking shield (222) is able to be converted between on/off, and thus the convert the modes between 2D/3D is possible. That is, in the case of 2D mode, the blocking shield (222) gets off to let the light penetrate so that 2D images can be presented; and in the case of 3D mode, the blocking shield (222) gets on to block the light so that stereoscopic images can be presented.

1. A parallax-barrier type stereoscopic display apparatus comprising:
an emitting light module for displaying plurality of colored lights in sequence per unit time (T1);
a display panel, in which pixels for the left eye and pixels for the right eye are arranged one after the other with pixel units, and which adjusts with pixel unit the penetrating amount of each colored light displayed in sequence by said emitting light module, so that images for the left eye and images for the right eye which are arranged one after the other are displayed; and
a barrier which is disposed with a predetermined distance from said display panel and selectively shows images for the left eye and images for the right eye.

2. The apparatus according to claim 1,
wherein said emitting light module comprises a light source module including plurality of colored-light sources, and a light diffusion plate for diffusing lights generated by said light source module, and
wherein each colored light source of said light source module generates each colored light per the unit time (T1), and sequentially display them on the entire light-outputting surface of said light diffusion plate.

3. The apparatus according to claim 1 or claim 2,
wherein said plurality of colored lights includes red (R) light, green (G) light and blue (B) light, and
wherein said plurality of colored-light sources comprises red (R) light source, green (G) light source and blue (B) light source.

4. The apparatus according to claim 1 or claim 2,
wherein pixels of said display panel adjusts the penetrating amount of each colored light within the unit time (T1), per time (T2) unit represented by the unit time (T1) multiplied by the number of each colored light (N) included in said emitting light module, so as to be able to display images for the left eye at the pixel for the left eye and images for the right eye at the pixel for the right eye.

5. The apparatus according to claim 1 or claim 2,
wherein said barrier exclusively used for stereoscopic view

6. The apparatus according to claim 1 or claim 2,
wherein said barrier comprises TN-LCD or STN-LCD for converting modes of plane/stereoscopic view.

7. The apparatus according to claim 1 or claim 2,
wherein said barrier comprises a blocking shield arranged at every two pixels in the vertical direction.

8. The apparatus according claim 7,
wherein the pitch of said blocking shield can be determined within the range of Pp×0.4 to Pp×0.8 when Pp is determined within the range of 2×Dp×0.8 to 2×Dp;
wherein said Pp is a panel pitch, and said Dp is dot pitch of a pixel; and
Pp=2×Dp×(S−L)/S while S is the viewing distance; and L is the distance between the display panel and the barrier.
